(19) United States
(12) Patent Application Publication
(10) Pub. No.: US 2025/0069104 A1
(43) Pub. Date: Feb. 27, 2025

(54) Predicting Product Demand with Cluster-Based Product Cross-Elasticity Estimates

(71) Applicant: Oracle International Corporation, Redwood Shores, CA (US)

(72) Inventors: Yu Zhao, Quincy, MA (US); David Richard Anderson, Saint Paul, MN (US); Saraswati Yagnavajhala, Johns Creek, GA (US)

(73) Assignee: Oracle International Corporation, Redwood Shores, CA (US)

(21) Appl. No.: 18/454,697

(22) Filed: Aug. 23, 2023

(51) Int. Cl. G06Q 30/0201

(52) U.S. Cl. CPC G06Q 30/0206

(57) ABSTRACT

Techniques for generating a retail forecasting model from product-cluster-based estimated elasticity values to forecast the effects of price changes on the demand for a set of products are disclosed. A system generates cluster-based price-elasticity values for a set of products by applying a set of regressive elasticity-estimation algorithms to a set of product data and clustering products based on product descriptions and estimated price-elasticity values. The system uses the cluster-based price-elasticity values for the products to generate the retail forecasting model.

### TECHNICAL FIELD

The present disclosure relates to product demand predictions. In particular, the present disclosure relates to applying cluster-based cross-elasticity estimates to product demand models to generate product-level demand predictions.

### BACKGROUND

When a retailer changes the price of a product, the retailer tends to sell more or fewer products, depending on whether the change is a price decrease or a price increase. For example, a sale price discount tends to result in more products being sold. A higher price tends to result in fewer products being sold. In addition, the sales of similar products tend to be affected. For example, an increase in price of one brand of butter is likely to result in an increase in sales of another brand of butter. Retail forecasting systems typically provide estimates of the effect of price changes on an item's own sales. This price response is referred to as the item's own-price or self-price elasticity. This means, for example, that a retailer planning to reduce an item's price for a promotion will have an estimate of the magnitude of the increase in sales for the item during the promotion. However, many retail forecasting systems do not provide estimates of the effects of changes in an item's price on other items' sales. Estimates of the effects of changes in one item's prices on sales of similar items are known as cross-elasticity estimates. Without cross-elasticity estimates, a retailer promoting an item will not know to what extent sales of similar items will change. As a result, retailers cannot determine the full costs and benefits of price changes, such as whether price changes will increase net revenue or margins.

Retail forecasting systems typically do not estimate cross-elasticity because of the difficulty of making these estimates. Even systems that generate estimates have difficulty generating accurate estimates across large numbers of products. Estimating cross-elasticity involves problems that are not present when estimating own-price elasticity. First, retailers and product demand models have difficulty identifying groups of items for which to estimate cross-elasticity. Retail categories often have hundreds or even thousands of products, and each product is associated with a unique stock keeping unit (SKU). Attempting to estimate cross-elasticity values for hundreds of SKUs has not hitherto been possible computationally, because there are thousands of potential cross-elasticity values to estimate. Data limitations (such as lack of sales information and incomplete product descriptions) often result in models lacking information to estimate cross-elasticity values for many product pairs. Even when there is enough information to estimate many cross-elasticity values, estimating large numbers of cross-elasticity values leads to many instances of erroneously identifying a cross-elasticity estimate as being significant when it is not.

Another problem that arises when attempting to calculate cross-elasticity is that the magnitude of cross-price effects tends to be smaller than the magnitude of own-price effects. The smaller magnitude of cross-price effects occurs both because demand that shifts to other SKUs may be spread across multiple SKUs and because some demand may be lost. Most pairs of SKUs will not be perfect substitutes, so a price change in one will result in only a limited amount of substitution to other SKUs. When multiple SKUs are substitutes, only a limited amount of demand is available to shift to each of the similar SKUs. Changes in prices can also lead consumers to make larger or smaller purchases in a category overall. A price increase in one SKU will normally have three effects. First, it will reduce the units sold for the SKU by a certain amount. Second, some of the demand from for the SKU will shift to other SKUs, and third, some demand will be lost to the category as consumers forgo some purchases altogether. The demand that is lost to the category will show up in own-price elasticity estimates but it will not in cross-elasticity estimates. Given the smaller magnitude of cross-price effects, conventional models have difficulty generating accurate cross-elasticity estimates.

Yet another problem that arises when attempting to calculate cross-elasticity is referred to as collinearity. Collinearity occurs because retailers often make price changes for similar items at the same time. A retailer may run a promotion for all items in a certain brand on a regular schedule. In addition, a retailer may run a promotion for a group of similar items during certain holidays. When price changes occur for multiple items at the same time, there may be no way to determine which of the items' price changes were responsible for changes in the sales of other items. Standard regression approaches may provide unreliable results or may not produce any results at all when there is high collinearity across price series.

Yet another problem that arises when attempting to estimate cross-elasticity is reconciling elasticity estimates across multiple items with economic constraints. This occurs due to “noise” in initial estimates and limits on the types of results that are possible economically. The three problems listed above make estimation more difficult and increase the amount of noise in initial cross-elasticity estimates.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIGS. 2A-2C illustrate an example set of operations for predicting product demand using cluster-based product price elasticity estimates in accordance with one or more embodiments;

FIGS. 3A-3C illustrate an example set of operations for predicting product demand using cluster-based product price elasticity estimates in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. MODELING PRODUCT DEMAND USING CLUSTER-BASED PRICE
ELASTICITY ESTIMATED VALUES
4. EXAMPLE EMBODIMENT
5. COMPUTER NETWORKS AND CLOUD NETWORKS
6. MISCELLANEOUS; EXTENSIONS
7. HARDWARE OVERVIEW

### 1. General Overview

One or more embodiments generate a retail forecasting model from product-cluster-based estimated elasticity values to forecast the effects of price changes on the demand for a set of products. A system generates cluster-based price-elasticity values for a set of products. The system uses the cluster-based price-elasticity values for the products to generate the retail forecasting model. The system generates the cluster-based price-elasticity values by performing operations to cluster products based on product descriptions and preliminary elasticity values and then determining estimated elasticity values based on the clustered products.

One or more embodiments initially cluster products according to product description attributes. For example, a retailer typically uses stock keeping units (SKUs) to provide text-based descriptions of products. The SKU descriptions include words, abbreviations, and codes to describe products. The system applies a natural language processing (NLP) model and a cosine similarity algorithm to create NLP-based product clusters. The NLP model may apply a term-frequency, inverse document frequency (TF-IDF) algorithm to generate a numerical frequency matrix including TF-IDF values for terms in the SKU product descriptions. The NLP model applies the cosine similarity algorithm to generate, for each pair of products among the plurality of products, a textual similarity score based on the TF-IDF values. The system clusters the products in NLP-based product clusters based on the textual similarity scores.

One or more embodiments generate elasticity-based sub-clusters among the NLP-based product clusters. The system generates the elasticity-based sub-clusters by applying a product-level regression or other elasticity estimation regression algorithm to the NLP-based clusters to generate an initial set of product-level elasticity estimates for key/target product pairs. The system then compares values of the product-level elasticity estimates for the key/target product pairs in the NLP-based clusters to cluster together sets of target products into sub-clusters which have product-level elasticity estimates that meet a particular clustering threshold. The system generates cluster-based elasticity estimates by applying a cluster-level elasticity estimation regression algorithm to the sub-clusters. The system then passes the cluster-based elasticity values to the individual members of the sub-clusters, while modifying the cluster-based values according to demand attributes of the individual member products. For example, if a sub-cluster includes two products, if a total demand for the products is 1000 units in a particular time interval, if one product is associated with 300 units, and if the other product is associated with 700 units, then the system may pass the cluster-level elasticity estimates to the cluster members by multiplying the cluster-level elasticity values for one product by 0.7 and for the other product by 0.3. The result is a product-level elasticity value for the cluster members that takes into account collinearity, or an effect of modifying the price for both cluster members at the same time.

One or more embodiments further refine the cluster-based elasticity values for the sub-cluster members based on attributes of the cluster members. For example, the system modifies a cross-elasticity for a particular product according to a magnitude of the self-price elasticity of the product. The system reduces a refined cross-elasticity value for a product that has a relatively low estimated self-price elasticity value. The system also reduces a refined cross-elasticity value for a product based on determining that a magnitude of demand for the product is relatively low. For example, a product with a demand of 100 units sold in a particular time interval would have a lower cross-elasticity (e.g., a change in the product's price would have a reduced effect on the demand for other products) than a product with a demand of 10,000 units sold over the particular time interval. The system also reduces a refined cross-elasticity value for a product based on there being a relatively high number of substitute products. For example, a change in price to a product associated with three substitute products will have less effect on the demand for the three substitute products than a change in price to a product associated with only one substitute product.

One or more embodiments apply the product demand model, generated based on the refined product-level price elasticity values, to price data for a set of products to predict demand for one or more products among the set of products. For example, a retailer may store prices for all the products sold by the retailer in a product management platform. The retailer may provide the price data, including proposed modifications to the prices for a set of products, to the product demand model. The product demand model predicts demand for both the price-changed products and for substitute products corresponding to the price-changed products. According to one example, the model identifies for the retailer the substitute products based on the refined product-level price elasticity values. According to another example, the model may recommend prices for products that meet defined criteria. For example, the model may recommend prices to maximize a retailer's profit or move inventory within a specified timeframe.

One or more embodiments described in this Specification and/or recited in the claims may not be included in this General Overview section.

### 2. System Architecture

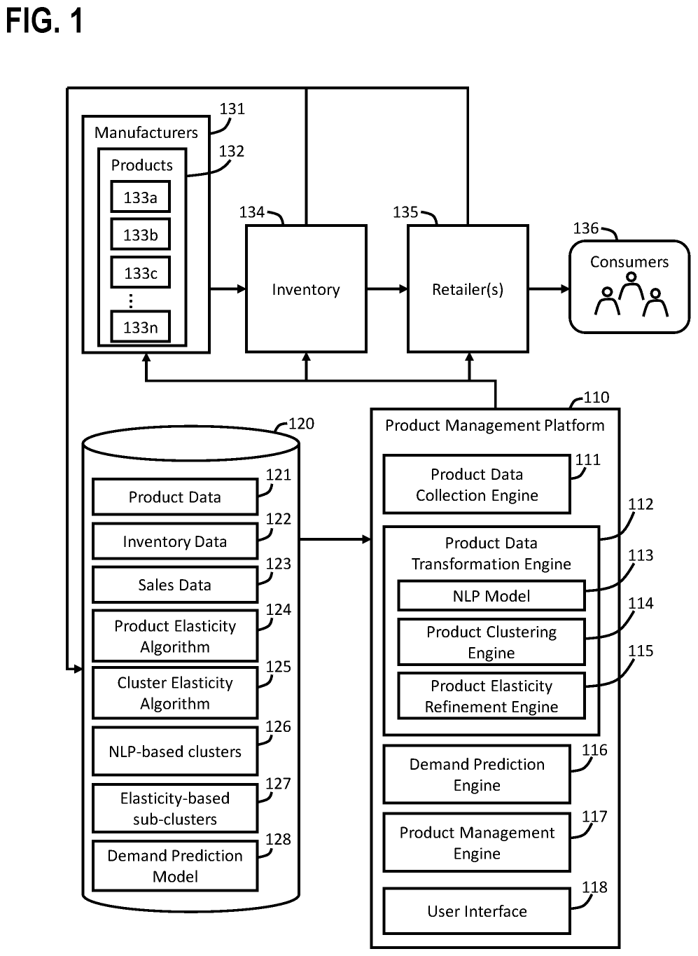

A system according to one or more embodiments includes a product management platform 110 and a data repository 120. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

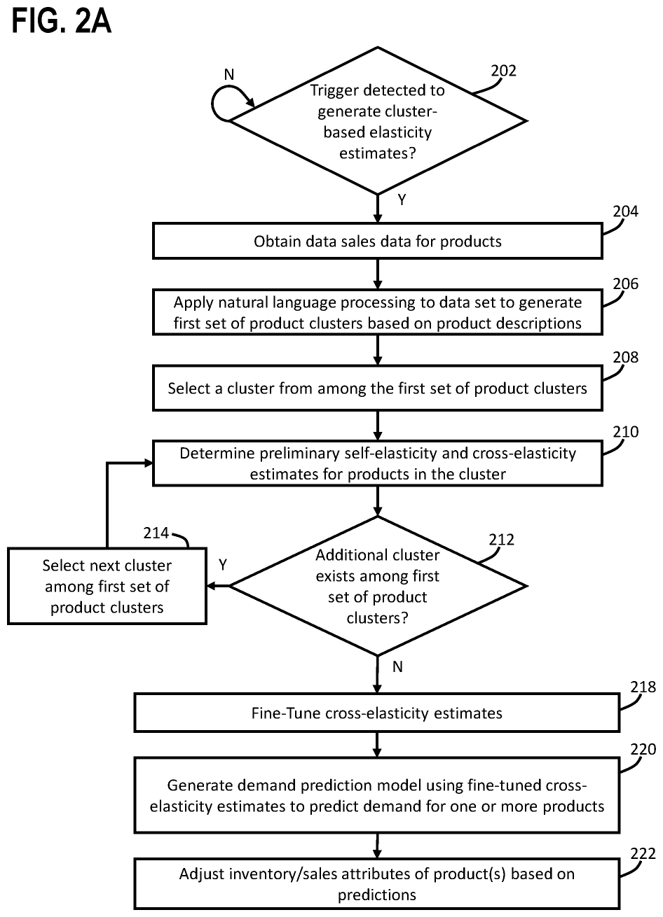

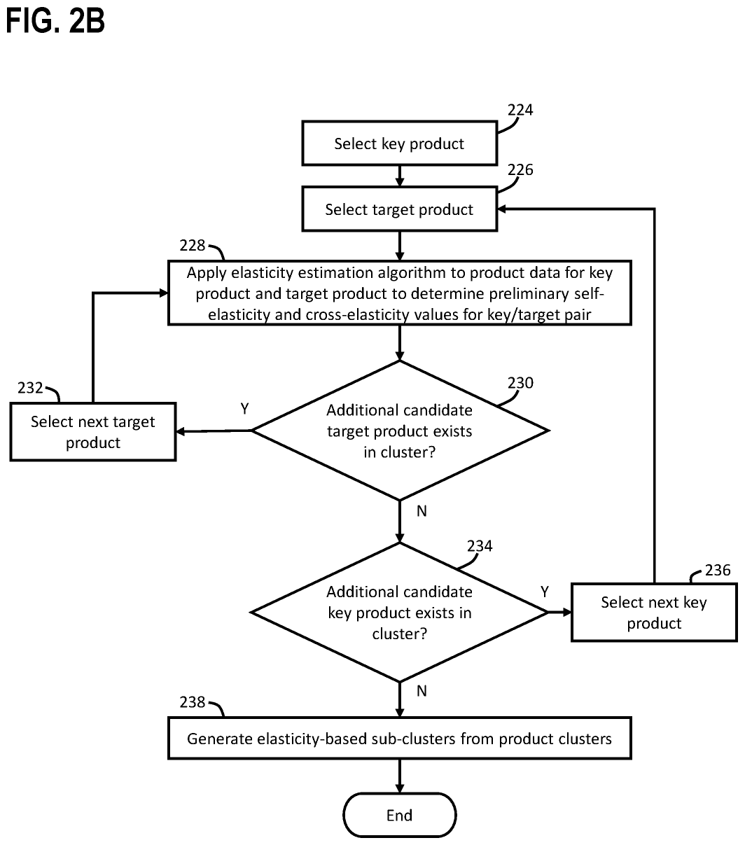

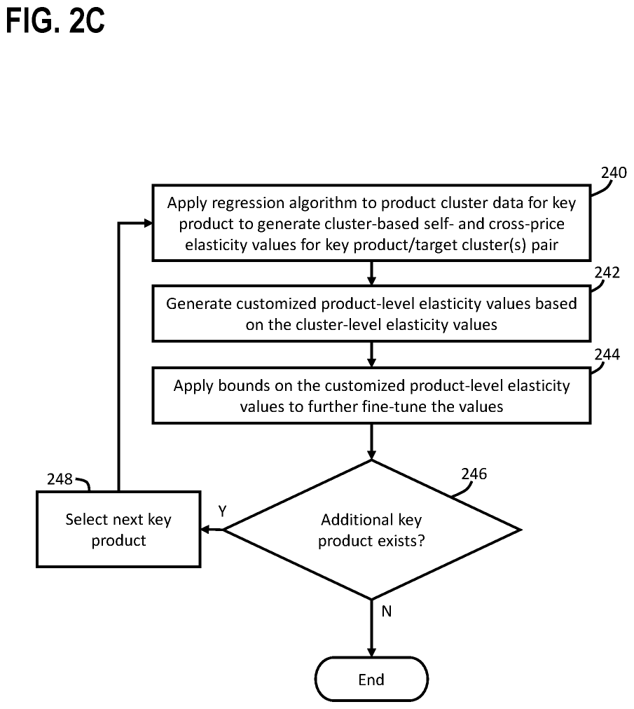

In one or more embodiments, the product management platform 110 refers to hardware and/or software configured to perform operations described herein for predicting product demand based on cluster-based product price elasticity estimates. Examples of operations for predicting product demand based on cluster-based product price elasticity estimates are described below with reference to FIGS. 2A-2C.

In an embodiment, the product management platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

The product management platform 110 includes a product data collection engine 111 to obtain data from one or more of a manufacturer 131, an inventory 134 (or other product storage locations), or a retailer 135. The manufacturers 131 manufacture products 132, including products 133a-133n. The products 132 are stored in inventory locations 134 or sent directly to a retailer 135. Consumers 136 purchase the products 132 from the retailer 135. Retailers 135 track products by assigning unique stock keeping units (SKUs) to the products. Retailers 135 store the SKUs as product data 121. The product data 121 may include, for each product, a unique tracking number, a textual description, which may include one or more of words, abbreviations, and codes, serial numbers, and model numbers. The inventory locations 134 and retailers 135 generate inventory data 122 and sales data 123. The inventory data 122 and sales data 123 include time-series data. For example, a retailer 135 may track daily or weekly sales data including the prices of products and quantities sold.

A product data transformation engine 112 applies a natural language processing (NLP) model 113 to a set of sales data corresponding to a particular set of products 132. For example, a user may interact with a user interface 118 to select one or more products for which the user enters price changes to initiate a demand prediction for the products and any substitute products. In one or more embodiments, interface 118 refers to hardware and/or software configured to facilitate communications between a user and the product management platform 110. Interface 118 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 118 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 118 is specified in one or more other languages, such as Java, C, or C++.

The system obtains product descriptions for each product. For example, if the sales data includes SKUs, the system obtains product descriptions associated with the SKUs from the product data 121.

According to one embodiment, the NLP model applies a term-frequency, inverse document frequency (TF-IDF) algorithm to assign a weight value to words, abbreviations, and codes within a SKU. The TF-IDF algorithm is a numerical statistic algorithm used to evaluate the importance of the word, abbreviation, or code for differentiating one SKU from another. For example, two SKUs may be directed to two different milk products. One SKU includes the terms “MILK-CHOC.” The other SKU includes the terms “MILK-STRW”. The TF-IDF algorithm assigns a higher weight to the codes (i.e., “CHOC” and “STRW”) than to the word “milk,” since MILK is found in both SKUs, and since the abbreviations “CHOC” and “STRW” are each found in only one of the SKUs. In other words, the unique codes in the SKUs are more useful for distinguishing between the products than the word “MILK.”

According to one embodiment, a formula for calculating TF-IDF for a term in an SKU within a collection of SKUs is: TF (Term Frequency)*IDF (Inverse Document Frequency). The term frequency measures how frequently a term appears in a specific SKU. It is calculated as the number of times the term occurs in the SKU divided by the total number of terms in the SKU. The term frequency component generates a value indicative of the importance of a term in an SKU. The inverse document frequency measures how rare or unique a term is across the entire collection of SKUs. According to one embodiment, the IDF value is calculated as the logarithm of the total number of SKUs divided by the number of documents that contain the term, and then the result is inverted.

By calculating the TF-IDF scores for each term in an SKU, the system generates values for each term that represent the importance of the terms across the entire set of SKUs. According to one embodiment, calculating TD-IDF values for the terms in a set of SKUs transforms the SKUs into a numerical feature matrix. Each row of the numerical feature matrix represents a SKU and each column represents a term in the SKU, with its corresponding TF-IDF score. This matrix can then be used as input for a clustering-type machine learning model.

According to one or more embodiments, the system applies a cosine similarity algorithm to the TF-IDF values for each SKU to generate similarity scores for each SKU. For example, the system may represent an SKU as a set of terms and weights corresponding to each term. The system may compare two SKUs based on (a) the set of matching terms, and (b) the weight assigned to the terms. The system may select a particular SKU and generate cosine similarity values for a set of additional SKUs. The set of additional SKUs may be selected based on the presence of identical or related terms in the product descriptions of the SKUs. According to one embodiment, the cosine similarity score for a particular SKU, B, compared to a key SKU, A, is calculated by applying the formula:

$$sim ( A , B ) = cos ( θ ) = \frac{A \cdot B}{‖ A ‖ ‖ B ‖}$$

A product clustering engine 114 generates the NLP-based product clusters 126 by applying a set of rules to the data set including SKUs, sales data, and similarity scores. The system clusters together SKUs that (a) have revenue values, for a particular period of time, which exceed threshold revenue value, and (b) have cosine similarity scores closer than a threshold percentage of SKUs. For example, the system may identify a set of 300 SKUs in a category “Yogurt.” The system may cluster together ten SKUs based on determining (a) the SKUs have generated at least $5000 in revenue during a defined period of time, and (b) the SKUs have cosine similarity scores within 0.05 of each other, corresponding to the 95th percentile, among the 300 SKUs.

According to an alternative embodiment, the NLP model 113 includes a machine learning model. The NLP machine learning model receives SKU description terms as input data and generates embeddings for SKUs. Training the NLP type machine learning model includes preprocessing a data set. The system collects a large dataset of SKUs. The system tokenizes the SKUs by dividing the SKUs into distinct words, abbreviations, and codes. The system converts numerical representations of the SKUs into dense vectors, or embeddings. The embeddings capture semantic relationships between words, abbreviations, and codes. The embeddings represent the words, abbreviations, and codes of the SKU in a continuous vector space. The system trains the NLP type machine learning model to generate embeddings for SKUs such that embeddings for more-closely-related SKUs are closer to each other in the continuous vector space than to embeddings for less-closely-related SKUs.

The system applies a clustering-type machine learning model to the set of data generated by the NLP-type model, such as the numerical matrix generated by the TF-IDF type model or the embeddings generated by the NLP-type machine learning model, to generate the product clusters. For example, the system may apply a trained clustering algorithm, such as K-Means, Hierarchical Clustering, DBSCAN (Density-Based Spatial Clustering of Applications with Noise), and Gaussian Mixture Models (GMMs). The clustering machine learning model assigns each data point, or each embedding representing an SKU, to a nearest cluster center based on a distance metric, such as a Euclidean distance, from the data point to the cluster center. According to one or more embodiments, if a data point is not within a threshold distance from a cluster center, the model designates the data point as a new cluster center. For example, in a K-Means type machine learning model, the system assigns each data point to the nearest centroid. The system then calculates a new centroid based on the mean of the points assigned to it. The process iterates until the centroids no longer change beyond a threshold level of change, or until a specified maximum number of iterations is reached.

The product clustering engine 114 applies a price elasticity estimation regression algorithm 124 to the NLP-based product clusters to generate, for each product in a set of products, initial self-price and cross-elasticity values. The price elasticity estimation regression algorithm includes sales and demand values and coefficients for a key product and sales and demand values and coefficients for a target product. In particular, the price elasticity estimation regression algorithm includes: (a) a key sales value, representing a total number of sales of a key product at a particular retail location (“store”) during an interval of time, (b) an offset value, (c) a key-product self-price coefficient, (d) a key product price value, representing an average price of the key product at the store over the interval of time, (e) a base demand coefficient, (f) an average sales value, representing the average sales of the key product at the store over a duration of time including a multiple of intervals of time (for example, if an interval of time is a week, the value is calculated for an entire year, or over 52 weeks), (g) a seasonality coefficient, (h) a total sales value, representing total sales for all goods at a particular store in the interval of time, (i) a target product sales coefficient, (j) a target product sales value, representing the sales of the target product at the store over the interval of time, (k) a cross-price coefficient, and (l) a price value, representing an average price for the target product at the store over the interval of time. The system performs a regression on the input data set including sales data for the SKUs of the particular product cluster to determine values for the coefficients, including the self-price coefficient for the key product and the cross-price coefficient for the target product. In one or more embodiments, the self-price coefficient corresponds to a self-price elasticity value, representing a relationship between a change in a product's price and a change in the products demand, and the cross-price coefficient corresponds to a cross-elasticity value, representing a relationship between a change in a key product's price and in a target product's demand.

The product clustering engine 114 generates elasticity-based sub-clusters of target products based on determining: (a) the key product has a negative self-price coefficient value, (b) the key product self-price coefficient value exceeds a threshold value, (c) the target product has a positive cross-price coefficient value, and (d) the target product cross-price coefficient value exceeds a threshold value. For example, in an embodiment in which the self-price coefficient value and the cross-price coefficient value are values between 0 and 1, the threshold for both may be 0.4 (e.g., −0.4 for the self-price coefficient, +0.4 for the cross-price coefficient). Alternatively, the threshold may be different for the self-price coefficient and the cross-price coefficient. As an example, the threshold for the self-price coefficient may be 0.3 (i.e., “−0.3”) and the threshold for the cross-price coefficient may be 0.5.

The product data transformation engine 112 applies a cluster elasticity estimation regression algorithm 125 to generate a set of cluster-based self-price and cross-elasticity estimates for each of the elasticity-based sub-clusters 127. For each product in each elasticity-based product cluster, the product data transformation engine 112 applies a modified cluster-based elasticity value to the product to generate a customized cluster-based elasticity value for the product. The product data transformation engine 112 modifies the cluster-based elasticity value for each product based on a proportion of sales of the product relative to other products in an elasticity-based product cluster.

A price elasticity refinement engine 115 performs a set of refinement operations on the customized cluster-based elasticity values. The price elasticity refinement engine 115 may apply limits to cross-elasticity values based on a key product's self-price elasticity value. For example, the price elasticity refinement engine 115 may reduce cross-elasticity values associated with products that have low self-price elasticity values. In other words, for a product in which a change in price results in little or no change in demand for the product, the product should not have high cross-elasticity values with other products. A change in the demand for the first product is likely to result in little to no change in demand for the substitute products.

In addition, the price elasticity refinement engine 115 may limit a product's cross-elasticity based on demand for the product. For example, if demand for a product is 100 units during a time interval, then a price change corresponding to the product should not result in any more than 100 units to substitute products.

In addition, the price elasticity refinement engine 115 may apply cross-elasticity bounds based on characteristics of other products, or substitute products, within a key product's elasticity-based product cluster. For example, if three other products exist in the elasticity-based product cluster, then a change in demand among the three other products, combined, should not be more than a total demand for the key product. In addition, since a change in price in a product results in some lost demand—or consumers who do not buy the product and do not buy substitutes—the system may further limit a total change in demand among substitute products to a value less than the total demand of the key product. For example, if the demand for the key product is 100 units for a given time interval, then a change in price for the product may result in demand to three substitute products totaling no more than 80 units (with 10 units corresponding to customers who are predicted to buy the key product at the higher price and 10 units corresponding to lost demand) distributed among the three substitute products.

The product management platform 110 includes a demand prediction engine 116 for predicting product demand based on the product price elasticity estimates generated by the product data transformation engine 112. The demand prediction engine 116 creates a demand prediction model 128 using the refined product-level price-elasticity values for a set of products to predict product demand for the set of products. For example, a user may access a GUI via the user interface 118 to provide the product management platform 110 with a set of price change data. The demand prediction engine 116 applies the demand prediction model 128, trained with the refined price elasticity values for a set of products, including the products associated with the price changes, to price data including the price change data and price data for other products for which no price changes may be indicated. The model 128 generates demand predictions corresponding to both (a) the products for which the price changes are indicated, and (b) other products, such as substitute products, for which the product data transformation engine 112 generated refined product-level cross-elasticity values. According to one example, the user provides proposed price changes, and the model 128 both (a) identifies substitute products, and (b) predicts demand changes for the substitute products.

The product management engine 117 generates instructions for the manufacturer 131, the inventory site 134 and/or the retailer 135 to manage production, product transfer, and/or product pricing based on the predictions generated by the demand prediction engine 116.

Additional embodiments and/or examples relating to computer networks are described below in Section 5, titled “Computer Networks and Cloud Networks.”

In one or more embodiments, a data repository 120 is any type of storage unit and/or device (e.g., a file system, database, collection of tables, or any other storage mechanism) for storing data. Further, a data repository 120 may include multiple different storage units and/or devices. The multiple different storage units and/or devices may or may not be of the same type or located at the same physical site. Further, a data repository 120 may be implemented or may execute on the same computing system as the product management platform 110. Alternatively, or additionally, a data repository 120 may be implemented or executed on a computing system separate from the product management platform 110. A data repository 120 may be communicatively coupled to the product management platform 110 via a direct connection or via a network.

Information describing product data 121, inventory data 122, sales data 123, elasticity algorithms 124 and 125, clusters 126 and 127, and the demand prediction model 128 may be implemented across any of components within the system 100. However, this information is illustrated within the data repository 120 for purposes of clarity and explanation.

### 3. Modeling Product Demand Using Cluster-Based Price Elasticity Estimated Values

FIG. 2A-2C illustrate an example set of operations for modeling product demand using cluster-based price-elasticity estimates in accordance with one or more embodiments. One or more operations illustrated in FIGS. 2A-2C may be modified, rearranged, or omitted all together. Accordingly, the particular sequence of operations illustrated in FIG. 1 should not be construed as limiting the scope of one or more embodiments.

A system detects a trigger to initiate a process for generating price elasticity estimates (Operation 202). A trigger may be automatically-generated or user-generated. For example, a user may interact with a graphical user interface (GUI) to select one or more products for analysis. The user may request a demand prediction for the products. According to one example, a user may interact with a GUI to generate a candidate price change for one or more products. According to one example, a user interacts with a GUI of a product management platform that allows the user to set prices for goods at one or more retail locations. The trigger may be detecting when the user enters a proposed price change to one or more products. Upon detecting the proposed price change, the system may automatically, without further user instructions, initiate operations to (a) estimate elasticity values for a set of products including the product for which the price change was proposed, and (b) generating a demand forecast for one or more products in the set of products. Alternatively, the system may periodically initiate operations to determine cluster-based, refined elasticity estimates for a set of products. When the user enters a proposed price change for one or more products, the system may apply a previously-generated demand-forecast model, which was trained using previously-determined cluster-based, refined elasticity values, to predict demand changes associated with the user's proposed price changes.

According to another example, the trigger includes detecting one or both of price changes and demand changes for one or more products in a set of product data. For example, a marketing platform may track a number of products sold and prices of the products over time. The system may set a threshold value for one or both of units sold and price change to initiate (a) estimating elasticity values for a set of products including the product for which the price change and/or demand change was detected, and (b) generating a demand forecast for one or more products. For example, the system may detect a price change of 10% to a competitor's product. The system may generate and/or update a self-price elasticity estimate and a cross-elasticity estimate for a user's product relative to the competitor's product. The system may further apply a demand prediction model to the product data, including the elasticity estimates, to predict a change in demand for the user's product based on the change in price to the competitor's product.

According to another example, a manufacturing management platform may detect a change in price and/or demand of one or more goods. The manufacturing management platform may initiate the estimating of elasticity values and demand prediction for products manufactured by a manufacturer to enable the manufacturer to modify production of products based on the demand predictions.

The system obtains sales data for products (Operation 204). The system may obtain product ID's, such as SKUs and prices for products sold by a retailer. The sales data includes product prices and numbers of items sold over a period of time. According to one example, the set of sales data includes sales data for thousands of products sold by a retailer from a particular retail location. According to another example, the sales data includes data for tens of thousands of products sold by a retailer from multiple different locations. According to yet another example, the sales data may include data for tens of thousands of products sold by multiple different retailers from multiple different locations.

The system applies a natural language processing (NLP) model to the set of sales data to generate a first set of product clusters (Operation 206). The system obtains product descriptions for each product. For example, if the sales data includes SKUs, the system obtains product descriptions associated with the SKUs. The product descriptions may include text content with both words and abbreviations. For example, a product description for a particular strawberry milk product includes the text: “DANNON OIKOS TZ STRWBRY”. The description includes both human-understandable text (e.g., “DANNON OIKOS”), human-discernable abbreviation, which is not a word or known abbreviation, but which human may readily recognize (e.g., “STRWBRY”), and a coded abbreviation, with a meaning that would not be apparent to a human (e.g., “TZ”). Another SKU may include only abbreviations. For example, a retailer may generate product SKUs with (a) an abbreviation for a company or brand name, (b) an alphanumeric code representing a product model and/or color, (c) a code representing a product size, and (d) a code representing a particular variant of the model. The SKU may omit any human-understandable words and abbreviations.

According to one embodiment, the NLP model applies a term-frequency, inverse document frequency (TF-IDF) algorithm to assign a weight value to words, abbreviations, and codes within a SKU. The TF-IDF algorithm is a numerical statistic algorithm used to evaluate the importance of the word, abbreviation, or code for differentiating one SKU from another. For example, two SKUs may be directed to two different milk products. One SKU includes the terms “MILK-C35Q.” The other SKU includes the terms “MILK-A456”. The TF-IDF algorithm assigns a higher weight to the codes (i.e., “C35Q” and “A456”) than to the word “milk,” since MILK is found in both SKUs, and since each code is found in only one of the SKUs. In other words, the codes are more useful for distinguishing between the products than the word “MILK.”

According to one embodiment, a formula for calculating TF-IDF for a term in an SKU within a collection of SKUs is: TF (Term Frequency)*IDF (Inverse Document Frequency)

The term frequency measures how frequently a term appears in a specific SKU. It is calculated as the number of times the term occurs in the SKU divided by the total number of terms in the SKU. The term frequency component generates a value indicative of the importance of a term in an SKU. The inverse document frequency measures how rare or unique a term is across the entire collection of SKUs. According to one embodiment, the IDF value is calculated as the logarithm of the total number of SKUs divided by the number of documents that contain the term, and then the result is inverted.

By calculating the TF-IDF scores for each term in an SKU, the system generates values for each term that represent the importance of the terms across the entire set of SKUs. According to one embodiment, calculating TD-IDF values for the terms in a set of SKUs transforms the SKUs into a numerical feature matrix. Each row of the numerical feature matrix represents a SKU and each column represents a term in the SKU, with its corresponding TF-IDF score. This matrix can then be used as input for a clustering-type machine learning model.

According to one or more embodiments, the system applies a cosine similarity algorithm to the TF-IDF values for each SKU to generate similarity scores for each SKU. For example, the system may represent an SKU as a set of terms and weights corresponding to each term. The system may compare two SKUs based on (a) the set of matching terms, and (b) the weight assigned to the terms. The system may select a particular SKU and generate cosine similarity values for a set of additional SKUs. The set of additional SKUs may be selected based on the presence of identical or related terms in the product descriptions of the SKUs. According to one embodiment, the cosine similarity score for a particular SKU, B, compared to a key SKU, A, is calculated by applying the formula:

$$sim ( A , B ) = cos ( θ ) = \frac{A \cdot B}{‖ A ‖ ‖ B ‖}$$

The system further generates the clusters by applying a set of rules to the data set including SKUs, sales data, and similarity scores. The system clusters together SKUs that (a) have revenue values, for a particular period of time, which exceed threshold revenue value, and (b) have cosine similarity scores closer than a threshold percentage of SKUs. For example, the system may identify a set of 300 SKUs in a category “Yogurt.” The system may cluster together ten SKUs based on determining (a) the SKUs have generated at least $5000 in revenue during a defined period of time, and (b) the SKUs have cosine similarity scores within 0.05 of each other, corresponding to the 95th percentile, among the 300 SKUs. The system refrains from including in the product clusters products that have not generated the threshold revenue during the defined time interval.

According to an alternative embodiment, the system trains an NLP type machine learning model to generate embeddings for SKUs. Training the NLP type machine learning model includes preprocessing a data set. The system collects a large dataset of SKUs. The system tokenizes the SKUs by dividing the SKUs into distinct words, abbreviations, and codes. The system converts numerical representations of the SKUs into dense vectors, or embeddings. The embeddings capture semantic relationships between words, abbreviations, and codes. The embeddings represent the words, abbreviations, and codes of the SKU in a continuous vector space. The system trains the NLP type machine learning model to generate embeddings for SKUs such that embeddings for more-closely-related SKUs are closer to each other in the continuous vector space than to embeddings for less-closely-related SKUs.

According to an embodiment, the system applies a clustering-type machine learning model to the set of data generated by the NLP-type model, such as the numerical matrix generated by the TF-IDF type model or the embeddings generated by the NLP-type machine learning model, to generate the product clusters. For example, the system may apply a trained clustering algorithm, such as K-Means, Hierarchical Clustering, DBSCAN (Density-Based Spatial Clustering of Applications with Noise), and Gaussian Mixture Models (GMMs).

According to one or more embodiments, the clustering machine learning model assigns each data point, or each embedding representing an SKU, to a nearest cluster center based on a distance metric, such as a Euclidean distance, from the data point to the cluster center. According to one or more embodiments, if a data point is not within a threshold distance from a cluster center, the model designates the data point as a new cluster center. For example, in a K-Means type machine learning model, the system assigns each data point to the nearest centroid. The system then calculates a new centroid based on the mean of the points assigned to it. The process iterates until the centroids no longer change beyond a threshold level of change, or until a specified maximum number of iterations is reached.

The system selects a cluster from among the first set of product clusters (Operation 208). The system determines preliminary estimated values for self-price elasticity of each product in the cluster and cross-elasticity of each product in the cluster with other products in the cluster (Operation 210). FIG. 2B illustrates a set of operations for determining preliminary estimated values for self-price elasticity of each product in a cluster and cross-elasticity of each product in the cluster with other products in the cluster based on applying an elasticity estimation regression algorithm.

The system selects a key product from among the products in the product cluster (Operation 224). For example, if a cluster includes SKUs for ten products, products 1-10, the system selects product 1 as a key product. The system selects a target product to pair with the key product for determining self-price and cross-price coefficient values for the key product and the target product (Operation 226). In the example in which a product cluster includes SKUs for products 1-10, and in which the system selected product 1 as the key product, the system selects product 2 as an initial target product.

The system applies an elasticity estimation regression algorithm to product data for the key product and the target product to determine a preliminary self-price elasticity value and a preliminary cross-elasticity value for the key/target product pair (Operation 228). The elasticity estimation regression algorithm includes the following elements: (a) a key sales value, representing a total number of sales of the key product at a particular retail location (“store”) during an interval of time, (b) an offset value, (c) a key-product self-price coefficient, (d) a key product price value, representing an average price of the key product at the store over the interval of time, (e) a base demand coefficient, (f) an average sales value, representing the average sales of the key product at the store over a duration of time including a multiple of intervals of time (for example, if an interval of time is a week, the value is calculated for an entire year, or over 52 weeks), (g) a seasonality coefficient, (h) a total sales value, representing total sales for all goods at a particular store in the interval of time, (i) a target product sales coefficient, (j) a target product sales value, representing the sales of the target product at the store over the interval of time, (k) a cross-price coefficient, and (l) a price value, representing an average price for the target product at the store over the interval of time. The system applies the elasticity-estimation regression algorithm to the input data set including sales data for the SKUs of the particular product cluster to determine values for the coefficients, including the self-price coefficient for the key product and the cross-price coefficient for the target product. In one or more embodiments, the self-price coefficient corresponds to a self-price elasticity value, representing a relationship between a change in a product's price and a change in the products demand, and the cross-price coefficient corresponds to a cross-elasticity value, representing a relationship between a change in a key product's price and in a target product's demand.

The system determines whether another candidate target product exists in the cluster (Operation 230). In the example in which a product cluster includes SKUs for products 1-10, in which the system selected product 1 as the key product, and in which the system performed the regression based on product 1 (key product) and product 2 (target product), the system determines that additional products (e.g., products 3-10) exist in the cluster.

Based on determining another product exists in the cluster, which has not yet been paired with the key product to estimate self-price and cross-elasticity values, the system selects the next candidate product (Operation 232). In the example in which a product cluster includes SKUs for products 1-10, in which the system selected product 1 as the key product, and in which the system performed the regression based on product 1 (key product) and product 2 (target product), the system selects product 3 as the next target product.

The system applies the elasticity estimation regression algorithm to the key product and the next target product (Operation 228). The system repeats operations 228, 230, and 232 until each product in the cluster has been paired with the key product. In other words, the system applies the elasticity estimation regression algorithm to key product 1 and target products 2, 3, 4, 5 . . . 10.

Based on determining that each product in the cluster has been paired with the key product, the system determines whether another candidate key product exists in the cluster (Operation 234). In the example embodiment in which the system applied the elasticity estimation regression algorithm to key product 1 and target products 2-10, respectively, the system determines that products 2-10 have not yet been selected as key products.

Based on determining that another candidate key product exists in the cluster, the system selects the next candidate as the key product (Operation 236). In the example embodiment in which the system applied the elasticity estimation regression algorithm to key product 1 and target products 2-10, respectively, the system next selects product 2 as the key product. The system repeats operations 228, 230, and 232 with the selected key product until the selected key product has been paired with each other product in the cluster as target products. The system repeats operations 234 and 236 until each product in the product cluster has been selected as the product key and the system has estimated self-price and cross-elasticity values for each key/target product pair in the cluster. In the example in which a product cluster includes products 1-10, the system applies the elasticity estimation regression algorithm to each key product/target product pair, including: key product 1, target products 2-10, respectively; key product 2, target products 1 and 3-10, respectively; key product 3, target products 1, 2, and 4-10, respectively; etc.

The system applies a set of clustering criteria to the self-price and cross-elasticity estimates for each key/target product pair to cluster the products into elasticity-based sub-clusters (Operation 238). In particular, the system determines, for the estimated elasticity values for each key/product pair, whether: (a) the key product has a negative self-price coefficient value, (b) the key product self-price coefficient value exceeds a threshold value, (c) the target product has a positive cross-price coefficient value, and (d) the target product cross-price coefficient value exceeds a threshold value. For example, in an embodiment in which the self-price coefficient value and the cross-price coefficient value for key/target product pairs are values between 0 and 1, the threshold for both may be 0.4 (e.g., −0.4 for the self-price coefficient, +0.4 for the cross-price coefficient). Alternatively, the threshold may be different for the self-price coefficient and the cross-price coefficient. As an example, the threshold for the self-price coefficient may be 0.3 (i.e., “−0.3”) and the threshold for the cross-price coefficient may be 0.5.

The system determines if any additional clusters exist for applying the elasticity estimation regression algorithm (Operation 212). In an example in which the system clustered a set of products into fifty NLP-based clusters, the system determines whether the elasticity estimation regression algorithm has been applied to products in each of the fifty clusters.

If an additional cluster exists, the system selects the next cluster (Operation 214). The system may apply the elasticity estimation regression algorithm to any set of goods, such as all goods within a category of goods, all goods sold at a particular retail location, or all goods across multiple retail locations.

The system fine-tunes the cross-elasticity estimates (Operation 218). FIG. 2C illustrates a set of operations for fine-tuning the cross-elasticity estimates. The system applies a cluster-based elasticity estimation regression algorithm to product cluster data associated with each key product to generate cluster-based values for self-price elasticity and cross-elasticity for the key product/cluster(s) pair (Operation 240). According to one or more embodiments, the cluster-based elasticity estimation regression algorithm includes (a) values corresponding to sales and demand for a key product, and (b) values corresponding to sales and demand for the elasticity-based sub-clusters associated with the key product. The system applies the cluster-based elasticity estimation regression algorithm to determine cluster-based self-price and cross-elasticity estimated values for the key product/cluster pairs. For example, if one product which has been selected as a key product is a member of three elasticity-based sub-clusters, the system applies the cluster-based elasticity estimation regression algorithm to the pair of: (a) the key product, and (b) the set of three elasticity-based sub-clusters associated with the key product. In particular, the system applies a cluster-based elasticity estimation regression algorithm to a single key product and one or more clusters, each comprising one or more target products. As such, the cluster-based elasticity estimation regression algorithm includes a single self-price coefficient and a plurality of cluster-based cross-price coefficients, each corresponding to a separate elasticity-based product cluster determined in Operation 238.

According to one example, the algorithm may include (a) a key sales value, representing a total number of sales of the key product at a particular retail location (“store”) during an interval of time, (b) an offset value, (c) a key-product self-price coefficient, (d) a key product price value, representing an average price of the key product at the store over the interval of time, (c) a base demand coefficient, (f) an average sales value, representing the average sales of the key product at the store over a duration of time including a multiple of intervals of time (for example, if an interval of time is a week, the value is calculated for an entire year, or over 52 weeks), (g) a seasonality coefficient, (h) a total sales value, representing total sales for all goods at a particular store in the interval of time, and, for each elasticity-based sub-cluster: (i) a target sub-cluster sales coefficient, (j) a target sub-cluster sales value, representing the sales of all the products in the target sub-cluster at the store over the interval of time, (k) a target sub-cluster cross-price coefficient, and (l) a target sub-cluster price value, representing an average price for the all the target products of the target sub-cluster at the store over the interval of time.

Upon generating cluster-based self-price and cross-elasticity estimates for the key product/cluster pairs, the system initiates a process to generate product-level fine-tuned self-price and cross-elasticity estimates.

For each product in an elasticity-based sub-cluster, the system generates customized product-level elasticity values based on the cluster-level elasticity values (Operation 242). The system determines the customized product-level elasticity values based on (a) the cluster-based self-price and cross-elasticity values determined in Operation 240 for all products in the same elasticity-based product cluster, and (b) a proportion of total sales of products for the cluster attributed to the product. For example, an elasticity-based clusters may be made up of three products, with sales being attributed as follows: Product 1: 50%, Product 2: 30%, product 3: 20%. Accordingly, the system may determine customized elasticity values for Product 1 based on determining: [cluster-based self-price and cross-elasticity values]×0.5. Similarly, the system may determine the customized elasticity values for Product 2 based on determining: [cluster-based self-price and cross-elasticity values]×0.3. Similarly, the system may determine the customized elasticity values for Product 3 based on determining: [cluster-based self-price and cross-elasticity values]×0.2. For example, if the cluster-based self-price and cross-elasticity values for a particular elasticity-based sub-cluster were calculated to be −0.5 and +0.8, respectively, the system may determine the customized self-price and cross-elasticity values for Product 1 to be −0.5×0.5=−0.25, and +0.8×0.5=+0.4, respectively. Likewise, the system may determine the customized self-price and cross-elasticity values for Product 2 to be −0.15 and +0.24, respectively. Likewise, the system may determine the customized self-price and cross-elasticity values for Product 3 to be −0.1 and +0.16, respectively.

The system further fine-tunes the customized elasticity values for the products by applying bounds on cross-elasticity values to generate cluster-based fine-tuned cross-elasticity values for each product (Operation 242). The system may apply limits to cross-elasticity values based on a key product's self-price elasticity value. For example, the system may reduce cross-elasticity values associated with products that have low self-price elasticity values. In other words, for a product in which a change in price results in little or no change in demand for the product, the product should not have high cross-elasticity values with other products. A change in the demand for the first product is likely to result in little to no change in demand for the substitute products.

In addition, the system may limit a product's cross-elasticity based on demand for the product. For example, if demand for a product is 100 units during a time interval, then a price change corresponding to the product should not result in any more than 100 units to substitute products.

In addition, the system may apply cross-elasticity bounds based on characteristics of other products, or substitute products, within a key product's elasticity-based product cluster. For example, if three other products exist in the elasticity-based product cluster, then a change in demand among the three other products, combined, should not be more than a total demand for the key product. In addition, since a change in price in a product results in some lost demand—or consumers who do not buy the product and do not buy substitutes—the system may further limit a total change in demand among substitute products to a value less than the total demand of the key product. For example, if the demand for the key product is 100 units for a given time interval, then a change in price for the product may result in demand to three substitute products totaling no more than 80 units (with 10 units corresponding to customers who are predicted to buy the key product at the higher price and 10 units corresponding to lost demand) distributed among the three substitute products.

The system determines whether another candidate key product exists among the set of products for which elasticity values are being determined (Operation 244). If another candidate key product exists, the system selects the next candidate as the key product (Operation 246). The system repeats operations 240, 242, and 244 with the new key product until each product has been selected as a key product, and cluster-based self-price and cross-elasticity values have been calculated for each key product. For example, in an example embodiment in which an elasticity-based product sub-cluster, generated in Operation 238, includes Products 1, 2, 6, and 7, the system selects each product in turn (e.g., 1, 2, 6, and 7) as the key product and applies the cluster-based elasticity estimation regression algorithm to each key product to determine, for each key product, cluster-based self-price and cross-elasticity values.

The system generates a demand-prediction model using the fine-tuned elasticity estimates to predict demand for the one or more products (Operation 220). According to one embodiment, the system trains the demand prediction model using the fine-tuned elasticity estimates. The model receives as input data price data for a set of products. The price data includes at least an initial set of price data and a modified set of price data. The modified data includes price changes to one or more products. Based on receiving the input data, the model predicts demand changes for the products for which the prices have changed, based at least on fine-tuned self-price elasticity values. The model also predicts demand values for one or more substitute products, as indicated by fine-tuned cross-elasticity values. According to one example embodiment, the system receives the price data as input data and generates as output data (a) a set of products that are substitutes for the products for which the prices are changed, and (b) demand predictions for both the price-changed products and the substitute products.

For example, a retailer may include as input data to the demand prediction model sales data for each product in a particular product category, such as “shirts” or “dairy”. The retailer may indicate a sale event in which the prices of ten items in the “shirts” category would be reduced in price by 10%. The demand prediction model generates predictions for changes in sales among the ten items, based on determined self-price elasticity values, and among other products in the “shirts” category, based on the fine-tuned cross-elasticity values. According to one example embodiment, the demand-prediction model generates one or more recommendations for maximizing specified sales metrics. For example, the model may apply a set of rules to predict prices for a set of products that would result in a specified quantity of the product being sold within four weeks. Alternatively, the model may apply a set of rules to predict prices that would maximize profits.

According to one embodiment, a product management platform (such as an inventory-management platform, a sales-management platform, or a platform that combines inventory and sales management) monitors sales data to detect changes in demand. The platform may compare sales to threshold values. Based on determining that sales of a particular product exceeds an upper threshold, or falls below a lower threshold, the system may trigger operations to (a) determine cluster-based self-price and cross-elasticity values for products related to the target products (as determined by applying a natural language processing model to SKU descriptions for the products), and (b) model demand and/or predicted target prices for the related products based on the monitored sales data. For example, the system may detect a drop off in sales in a particular brand of shoes. The system may model demand for candidate substitute shoes, based on cluster-based fine-tuned self-price and cross-elasticity estimated values to determine target prices for the substitute shoes.

The system adjusts inventory and/or sales attributes of products based on the predictions (Operation 222). For example, based on the predictions generated by the demand-prediction model, a retailer may direct a system to schedule a sale to reduce the prices of a set of products. Alternatively, the retailer may direct the system to increase prices of a set of products.

### 4. Example Embodiment

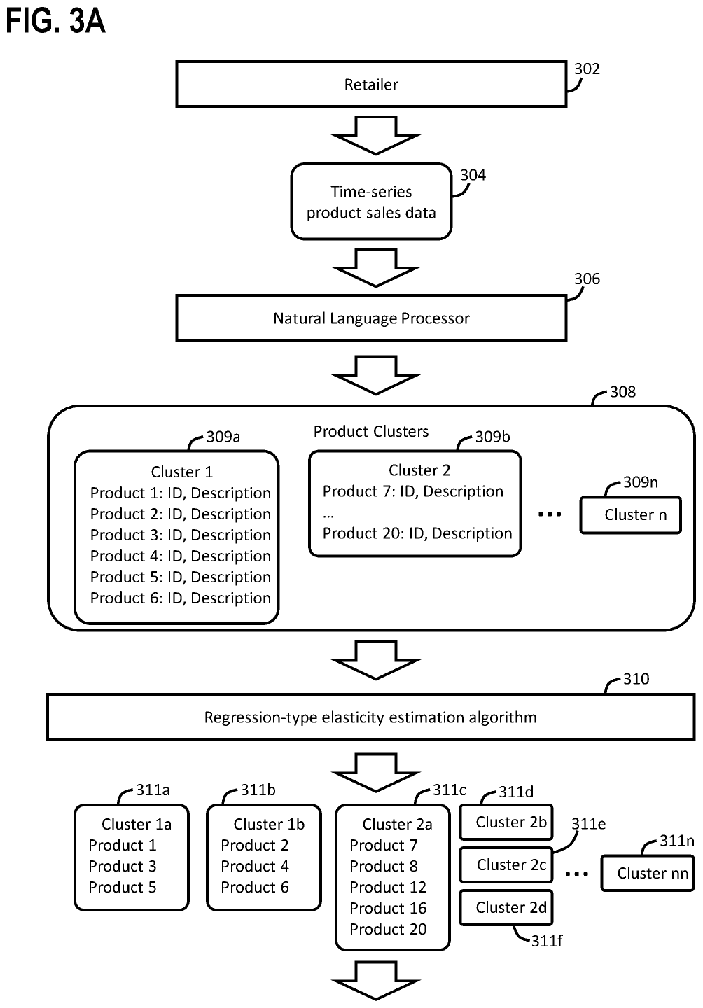

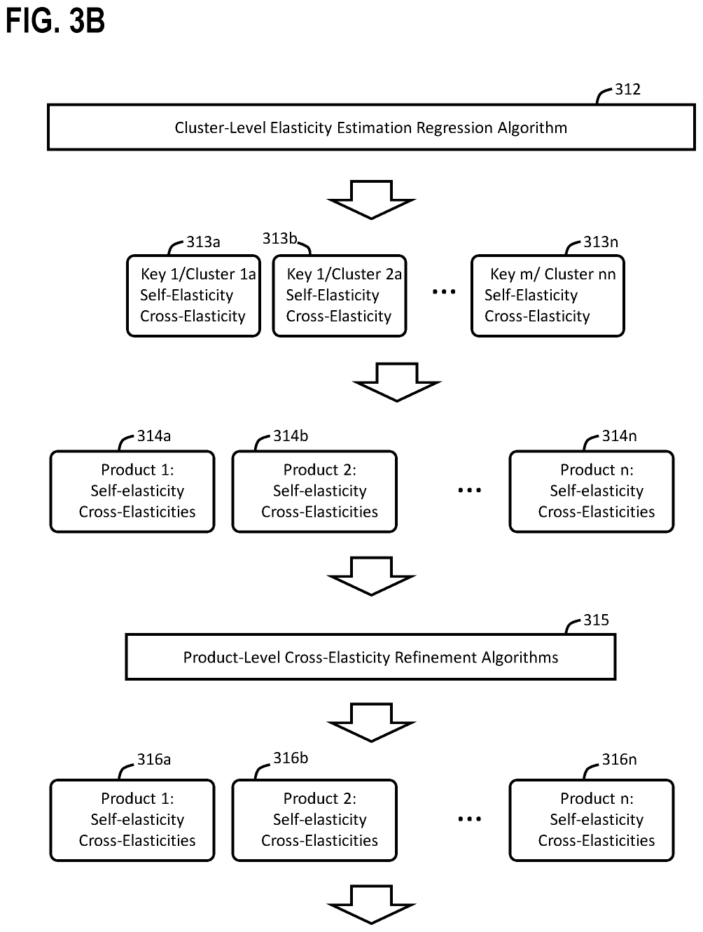

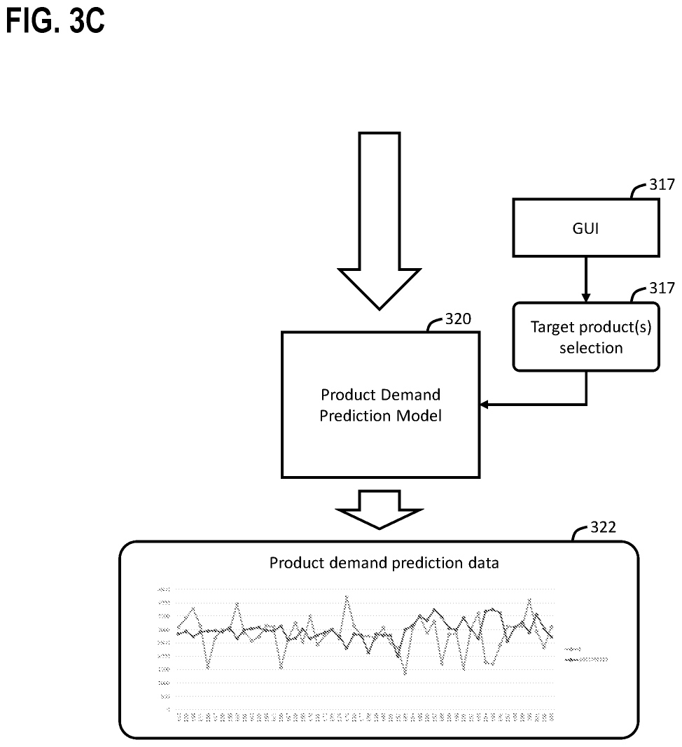

FIGS. 3A-3C illustrate an example embodiment.

A retailer 302 generates time-series product sales data by tracking the prices and sales of products corresponding to sales keeping units (SKUs). The retailer 302 would like to determine the effect of a set of proposed price changes at the beginning of a new season, including raising prices for at least one set of products and placing another set of products on sale.

The retailer provides sales data, including SKU descriptions, for products sold at a particular store to a natural language processing model 306. The retailer's SKUs include a particular format: (a) an abbreviation for a company or brand name, (b) an alphanumeric code representing a product model and/or color, (c) a code representing a product size, and (d) a code representing a particular variant of the model. The SKUs include a combination of human-understandable words (such as “milk,” “yogurt,” and “bread”), abbreviations (such as “strwbry,” “pln,” and “yel”), and codes (such as C2349 and P4455).

The NLP model applies a term-frequency, inverse document frequency (TF-IDF) algorithm to assign a weight value to words, abbreviations, and codes within a SKU. The TF-IDF algorithm is a numerical statistic algorithm used to evaluate the importance of the word, abbreviation, or code for differentiating one SKU from another. The NLP model transforms the SKUs into a numerical feature matrix. Each row of the numerical feature matrix represents a SKU and each column represents a term in the SKU, with its corresponding TF-IDF score. The system applies a cosine similarity algorithm to the TF-IDF values for each SKU to generate similarity scores for each SKU. The system generates NLP-based SKU clusters by applying a set of rules to a data set including SKUs, sales data, and similarity scores. The system clusters together SKUs that (a) have revenue values, for a particular period of time, which exceed threshold revenue value, and (b) have cosine similarity scores indicating a similarity equal-to or higher-than 95 percent of all SKUs in a particular product category.

FIG. 3A illustrates NLP-based product clusters 308, including a first cluster 309a, including products 1-6, a second cluster 309b, including products 7-20, up to n clusters 309n.

The system applies an elasticity estimation regression algorithm 310 to the clusters 309a-309n to generate elasticity-based sub-clusters 311a-311n. In particular, the system applies the elasticity estimation regression algorithm to each pair of products in cluster 1 (309a) to generate elasticity-based clusters 311a and 311b. Likewise, the system applies the elasticity estimation regression algorithm to each pair of products in cluster 2 (309b) to generate clusters 311c-311f. The system applies the elasticity estimation regression algorithm 310 to each pair of products in each cluster. In particular, for the cluster 309a, the system applies the algorithm to the following product pairs:

| Key | Key | Key | Key | Key |
|---|---|---|---|---|
| Product, | Product, | Product, | Product, | Product, |
| Target | Target | Target | Target | Target |
| Product | Product | Product | Product | Product |
| 1.2 | 2.3 | 3.5 | 5.1 | 6.3 |
| 1.3 | 2.4 | 3.6 | 5.2 | 6.4 |
| 1.4 | 2.5 | 4.1 | 5.3 | 6.5 |
| 1.5 | 2.6 | 4.2 | 5.4 | |
| 1.6 | 3.1 | 4.3 | 5.6 | |
| 2.1 | 3.2 | 4.5 | 6.1 | |
| 2.2 | 3.4 | 4.6 | 6.2 | |

For each key product/target product pair, the system applies the elasticity estimation regression algorithm to determine: (a) an initial self-price elasticity value for the key product/target product pair, and (b) an initial cross-elasticity value for the key product target/target product pair. The system generates the elasticity-based clusters 311a-311n by clustering together the target products associated with a same key product for which the self-price and cross-elasticity estimated values satisfy the following criteria: (a) the key product has a negative self-price coefficient value, (b) the key product self-price coefficient value exceeds a threshold value, (c) the target product has a positive cross-price coefficient value, and (d) the target product cross-price coefficient value exceeds a threshold value. In other words, each elasticity-based cluster 311a-311n includes (a) a single key product that satisfies the criteria (a) and (b) and one or more target products that satisfy the criteria (c) and (d).

The system applies a cluster-based elasticity estimation regression algorithm 312 to the elasticity-based clusters 311a-311n to generate cluster-based elasticity values 313a-313n. Applying the cluster-based elasticity estimation regression algorithm includes applying the algorithm to pairs comprising a single key product and a set of one or more product clusters 311a-312n to generate cluster-level self-price and cross-elasticity values 313a-313n.

The system passes the cluster-level self-price and cross-elasticity values 313a-313n to particular products by modifying the cluster-based elasticity values with sales-based values for each particular product in the cluster to generate product-level elasticity values 314a-314n. For example, cluster 311a includes Product 1, Product 3, and Product 5. The proportion of sales for Products 1, 3, and 5 is 60%, 30%, and 10%, respectively. The system generates the product-level elasticity values from the cluster-based elasticity values by multiplying the cluster-based elasticity values by the relative proportion of sales attributable to each product.

The system applies one or more refinement algorithms 315 to the product-level elasticity values 314a-314n to generate refined estimated elasticity values 316a-316n. Based on one refinement algorithm 315, the system applies limits to cross-elasticity values based on a product's self-price elasticity value. For example, the system may reduce cross-elasticity values associated with products that have low self-price elasticity values. In other words, for a product in which a change in price results in little or no change in demand for the product, the product should not have high cross-elasticity values with other products. A change in the demand for the first product is likely to result in little to no change in demand for the substitute products.

Based on another refinement algorithm 315, the system limits a product's cross-elasticity based on demand for the product. For example, if demand for a product is 100 units during a time interval, then a price change corresponding to the product should not result in any more than 100 units to substitute products.

Based on yet another refinement algorithm, the system applies cross-elasticity bounds based on characteristics of other products, or substitute products, within a key product's elasticity-based product cluster. For example, if three other products exist in the elasticity-based product cluster, then a change in demand among the three other products, combined, should not be more than a total demand for the key product. In addition, since a change in price in a product results in some lost demand—or consumers who do not buy the product and do not buy substitutes—the system may further limit a total change in demand among substitute products to a value less than the total demand of the key product. For example, if the demand for the key product is 100 units for a given time interval, then a change in price for the product may result in demand to three substitute products totaling no more than 80 units (with 10 units corresponding to customers who are predicted to buy the key product at the higher price and 10 units corresponding to lost demand) distributed among the three substitute products.

The system generates a product demand prediction model 320 based on the refined estimated elasticity values 316a-316n. The product demand prediction model 320 is trained to receive product price data as an input feature and to generate product demand data for both the product and additional products, including substitute products, based on the refined elasticity estimate values. The retailer interacts with a graphical user interface (GUI) to select a set of products for demand analysis (Operation 317). For example, the set of products may include a subset of products sold by the retailer, including products associated with proposed price changes, including increasing prices for some products, and decreasing prices for other products. The set of products may also include all the products that retailer sells. The product demand prediction model 320 receives price data for the selected set of products and generates product demand prediction data 322 for one or more products. According to one example embodiment, a retailer provides the product demand prediction model 320 with (a) current or historical price data for a set of products, and (b) price change data for one or more products among the set of products. Based on the refined estimated elasticity values 316a-316n on which the model 320 is trained, the model 320 generates output data (a) identifying a set of products, other than those identified by the retailer as having price changes, which are substitutes for the price-changed products, and (b) predicts demand changes for both the price-changed products and the substitute products. Accordingly, the model 320 provides the retailer with predictions regarding demand for goods sold by the retailer that take into account factors such as collinearity, low product demand, low product self-price elasticity, and a number of substitute products available that would be affected by price changes to a product.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

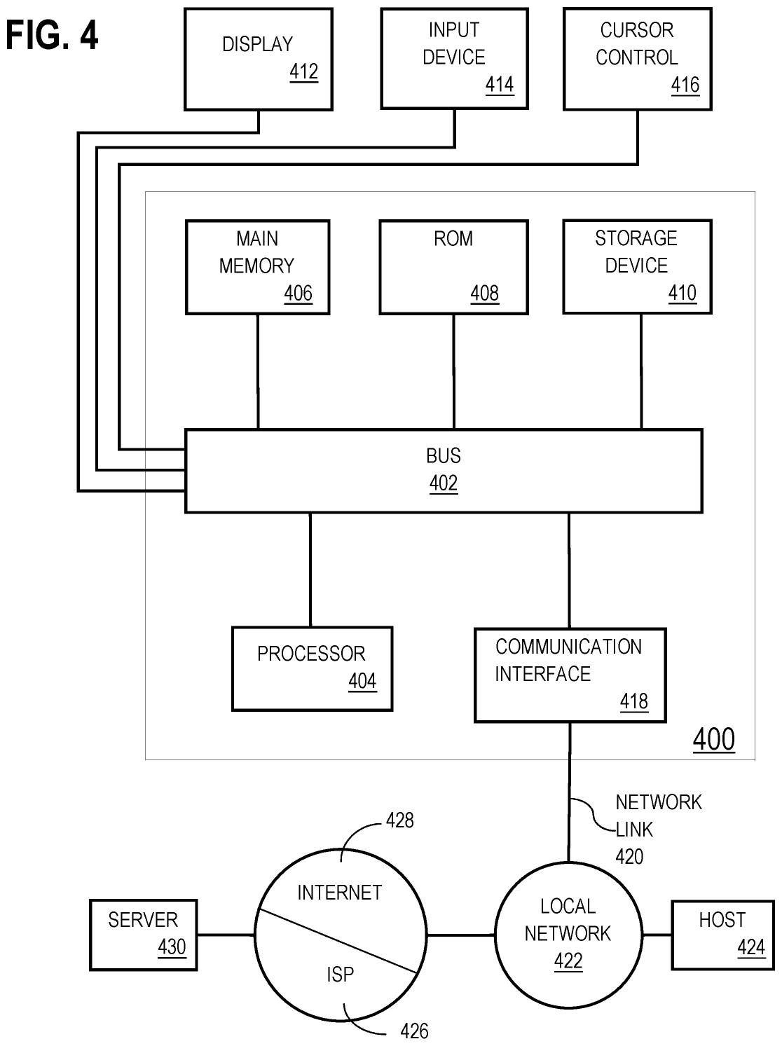

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which,
when executed by one or more hardware processors, causes performance of operations comprising:
generating a retail forecasting model for forecasting effects of price and demand changes among a plurality of products, at least by:
obtaining a set of product data comprising: sales data for the plurality of products and product descriptions for the plurality of products;
clustering the plurality of products into a plurality of product clusters according to textual similarities among the product descriptions of the plurality of products;
applying a cluster-level price elasticity estimation regression algorithm to the plurality of product clusters to generate a set of cluster-level estimated price elasticity values;
modifying the set of cluster-level estimated price elasticity values based on demand attributes of the plurality of products to generate a plurality of product-level price elasticity values for the plurality of products, at least by:
modifying a first cluster-level estimated price elasticity value for a first product cluster with a first demand value representing a demand level for a first product in the first product cluster to generate a first product-level price elasticity value corresponding to the first product; and
generating the retail forecasting model for the plurality of products based on the plurality of product-level price elasticity values.

2. The non-transitory computer readable medium of claim 1, wherein clustering the plurality of products into the plurality of product clusters according to textual similarities among the product descriptions of the plurality of products comprises:
applying a natural language processing (NLP) model to the product descriptions for the plurality of products to identify the textual similarities among the product descriptions; and
clustering, based on the textual similarities, the plurality of products into a set of NLP-based product clusters.

3. The non-transitory computer readable medium of claim 2, wherein the NLP model includes (a) a term-frequency, inverse document frequency (TF-IDF) algorithm to generate a numerical frequency matrix including TF-IDF values for terms in the product descriptions, and (b) a cosine similarity algorithm to generate, for each pair of products among the plurality of products, a textual similarity score based on the TF-IDF values.

4. The non-transitory computer readable medium of claim 2, wherein the NLP model generates a plurality of embeddings corresponding, respectively, to the plurality of products based on the product descriptions for the plurality of products, and
wherein clustering the plurality of products into the plurality of product clusters comprises:
applying a clustering-type machine learning model to the plurality of embeddings to generate the plurality of product clusters.

5. The non-transitory computer readable medium of claim 2, wherein the operations further comprise:
applying a product-level price elasticity estimation regression algorithm to respective pairs of products among the set of NLP-based product clusters to generate a first set of estimated price elasticity values for the plurality of products at least by:
applying the product-level price elasticity estimation regression algorithm to a first product and a second product in a first NLP-based product cluster to determine a first estimated elasticity value for the first product; and
applying the product-level price elasticity estimation regression algorithm to the second product and the first product in the first NLP-based product cluster to determine a second estimated elasticity value for the second product;
for each respective product cluster among the plurality of product clusters, comparing the first set of estimated price elasticity values of products in the respective product cluster to a clustering criterion to generate the plurality of product clusters, which are elasticity-based product sub-clusters of the NLP-based product clusters, at least by:
determining a first subset of products in the first product cluster satisfies the clustering criterion;
based on determining the first subset of products satisfies the clustering criterion:
clustering the first subset of products into a first elasticity-based product sub-cluster;
determining a second subset of products in the first product cluster satisfies the clustering criterion; and
based on determining the second subset of products satisfies the clustering criterion: clustering the second subset of products into a second elasticity-based product sub-cluster.

6. The non-transitory computer readable medium of claim 5, wherein applying the product-level price elasticity estimation regression algorithm to the respective pairs of products among the set of NLP-based product clusters comprises:
(a) generating a plurality of product pairs by:
(i) selecting a first product in a first NLP-based product cluster as a key product;
(ii) selecting a second product in the first NLP-based product cluster as a target product;
(b) applying the product-level price elasticity estimation regression algorithm to the key product and the target product to determine a self-price elasticity value for the key product in association with the target product and a cross-elasticity value for the key product in association with the target product; and
repeating operations (a) and (b) until each product among the plurality of products has been selected as the key product and paired with each other product, among the plurality of products, selected as the target product.

7. The non-transitory computer readable medium of claim 1, wherein the operations further comprise:
obtaining price change data for at least one product among the plurality of products;
applying the retail forecasting model to a set of modified price data for the plurality of products, including the price change data for the at least one product; and
generating, by the retail forecasting model, a demand forecast for the at least one product based on the price change data.

8. The non-transitory computer readable medium of claim 1, wherein the set of product data includes one or more of:
time-series data representing sales of the plurality of products;
a unique product identifier (ID) for each product among the plurality of products; and
a text-based product description for each product among the plurality of products.

9. The non-transitory computer readable medium of claim 1, wherein applying the cluster-level price elasticity estimation regression algorithm to the plurality of product clusters to generate the set of cluster-level estimated price elasticity values comprises:
(a) generating a plurality of key product/cluster pairs at least by:
(i) selecting a first product as a key product;
(ii) selecting at least one elasticity-based sub-cluster, from among the plurality of product clusters, as a target set of elasticity-based sub-clusters;
(b) applying the cluster-level price elasticity estimation regression algorithm to the key product and the target set of elasticity-based sub-clusters to determine a cluster-level self-price elasticity value for the key product in association with the target set of elasticity-based sub-clusters and a cluster-level cross-elasticity value for the key product in association with the target set of elasticity-based sub-clusters; and
repeating operations (a) and (b) until each elasticity-based sub-cluster has been paired, as a target elasticity-based sub-cluster in a set of elasticity-based sub-clusters, with each product selected as the key product.

10. The non-transitory computer readable medium of claim 1, wherein the operations further comprise:
generating a plurality of refined product-level price elasticity values from the plurality of product-level price elasticity values by performing at least one of:
reducing one or more product-level cross-elasticity values based on determining a corresponding product-level self-price elasticity value does not meet a self-price elasticity threshold value;
reducing the one or more product-level cross-elasticity values based on a demand level for a corresponding set of one or more products; and
reducing the one or more product-level cross-elasticity values based on a number of substitute products corresponding to a particular product, and
wherein the retail forecasting model is generated based on the plurality of refined product-level price elasticity values.

11. A method comprising:
generating a retail forecasting model for forecasting effects of price and demand changes among a plurality of products, at least by:
obtaining a set of product data comprising: sales data for the plurality of products and product descriptions for the plurality of products;
clustering the plurality of products into a plurality of product clusters according to textual similarities among the product descriptions of the plurality of products;
applying a cluster-level price elasticity estimation regression algorithm to the plurality of product clusters to generate a set of cluster-level estimated price elasticity values;
modifying the set of cluster-level estimated price elasticity values based on demand attributes of the plurality of products to generate a plurality of product-level price elasticity values for the plurality of products, at least by:
modifying a first cluster-level estimated price elasticity value for a first product cluster with a first demand value representing a demand level for a first product in the first product cluster to generate a first product-level price elasticity value corresponding to the first product; and
generating the retail forecasting model for the plurality of products based on the plurality of product-level price elasticity values.

12. The method of claim 11, wherein clustering the plurality of products into the plurality of product clusters according to textual similarities among the product descriptions of the plurality of products comprises:
applying a natural language processing (NLP) model to the product descriptions for the plurality of products to identify the textual similarities among the product descriptions; and
clustering, based on the textual similarities, the plurality of products into a set of NLP-based product clusters.

13. The method of claim 12, wherein the NLP model includes (a) a term-frequency, inverse document frequency (TF-IDF) algorithm to generate a numerical frequency matrix including TF-IDF values for terms in the product descriptions, and (b) a cosine similarity algorithm to generate, for each pair of products among the plurality of products, a textual similarity score based on the TF-IDF values.

14. The method of claim 12, wherein the NLP model generates a plurality of embeddings corresponding, respectively, to the plurality of products based on the product descriptions for the plurality of products, and
wherein clustering the plurality of products into the plurality of product clusters comprises:
applying a clustering-type machine learning model to the plurality of embeddings to generate the plurality of product clusters.

15. The method of claim 12, further comprising:
applying a product-level price elasticity estimation regression algorithm to respective pairs of products among the set of NLP-based product clusters to generate a first set of estimated price elasticity values for the plurality of products at least by:
applying the product-level price elasticity estimation regression algorithm to a first product and a second product in a first NLP-based product cluster to determine a first estimated elasticity value for the first product; and
applying the product-level price elasticity estimation regression algorithm to the second product and the first product in the first NLP-based product cluster to determine a second estimated elasticity value for the second product;
for each respective product cluster among the plurality of product clusters, comparing the first set of estimated price elasticity values of products in the respective product cluster to a clustering criterion to generate the plurality of product clusters, which are elasticity-based product sub-clusters of the NLP-based product clusters, at least by:
determining a first subset of products in the first product cluster satisfies the clustering criterion;
based on determining the first subset of products satisfies the clustering criterion:
clustering the first subset of products into a first elasticity-based product sub-cluster;
determining a second subset of products in the first product cluster satisfies the clustering criterion; and
based on determining the second subset of products satisfies the clustering criterion: clustering the second subset of products into a second elasticity-based product sub-cluster.

16. The method of claim 15, wherein applying the product-level price elasticity estimation regression algorithm to the respective pairs of products among the set of NLP-based product clusters comprises:
(a) generating a plurality of product pairs by:
(i) selecting a first product in a first NLP-based product cluster as a key product;
(ii) selecting a second product in the first NLP-based product cluster as a target product;
(b) applying the product-level price elasticity estimation regression algorithm to the key product and the target product to determine a self-price elasticity value for the key product in association with the target product and a cross-elasticity value for the key product in association with the target product; and
repeating operations (a) and (b) until each product among the plurality of products has been selected as the key product and paired with each other product, among the plurality of products, selected as the target product.

17. The method of claim 11, further comprising
obtaining price change data for at least one product among the plurality of products;
applying the retail forecasting model to a set of modified price data for the plurality of products, including the price change data for the at least one product; and
generating, by the retail forecasting model, a demand forecast for the at least one product based on the price change data.

18. The method of claim 11, wherein the set of product data includes one or more of:
time-series data representing sales of the plurality of products;
a unique product identifier (ID) for each product among the plurality of products; and
a text-based product description for each product among the plurality of products.

19. The method of claim 11, wherein applying the cluster-level price elasticity estimation regression algorithm to the plurality of product clusters to generate the set of cluster-level estimated price elasticity values comprises:
(a) generating a plurality of key product/cluster pairs at least by:
(i) selecting a first product as a key product;
(ii) selecting at least one elasticity-based sub-cluster, from among the plurality of product clusters, as a target set of elasticity-based sub-clusters;
(b) applying the cluster-level price elasticity estimation regression algorithm to the key product and the target set of elasticity-based sub-clusters to determine a cluster-level self-price elasticity value for the key product in association with the target set of elasticity-based sub-clusters and a cluster-level cross-elasticity value for the key product in association with the target set of elasticity-based sub-clusters; and
repeating operations (a) and (b) until each elasticity-based sub-cluster has been paired, as a target elasticity-based sub-cluster in a set of elasticity-based sub-clusters, with each product selected as the key product.

20. A system comprising:
one or more processors; and
memory storing instructions that, when executed by the one or more processors, cause the system to perform operations comprising:
generating a retail forecasting model for forecasting effects of price and demand changes among a plurality of products, at least by:
obtaining a set of product data comprising: sales data for the plurality of products and product descriptions for the plurality of products;
clustering the plurality of products into a plurality of product clusters according to textual similarities among the product descriptions of the plurality of products;
applying a cluster-level price elasticity estimation regression algorithm to the plurality of product clusters to generate a set of cluster-level estimated price elasticity values;
modifying the set of cluster-level estimated price elasticity values based on demand attributes of the plurality of products to generate a plurality of product-level price elasticity values for the plurality of products, at least by:
modifying a first cluster-level estimated price elasticity value for a first product cluster with a first demand value representing a demand level for a first product in the first product cluster to generate a first product-level price elasticity value corresponding to the first product; and
generating the retail forecasting model for the plurality of products based on the plurality of product-level price elasticity values.
